(19) United States
(12) Patent Application Publication
(10) Pub. No.: US 2023/0420805 A1
(43) Pub. Date: Dec. 28, 2023

(54) Separator for lithium-ion cells having high thermal conductivity

(71) Applicant: ZENTRUM FÜR SONNENENERGIE- UND WASSERSTOFF-FORSCHUNG BADEN-WÜRTTEMBERG GEMEINNÜTZIGE STIFTUNG, Stuttgart (DE)

(72) Inventors: Fabian MENZ, Senden (DE); Olaf BÖSE, Ulm (DE); Daniel BECHER, Ehingen (DE)

(73) Assignee: ZENTRUM FÜR SONNENENERGIE- UND WASSERSTOFF-FORSCHUNG BADEN-WÜRTTEMBERG GEMEINNÜTZIGE STIFTUNG, Stuttgart (DE)

(21) Appl. No.: 18/253,361

(22) PCT Filed: Nov. 17, 2021
(86) PCT No.: PCT/EP2021/081999

§ 371 Date: May 17, 2023

(30) Foreign Application Priority Data
Nov. 18, 2020 (DE) 10 2020 130 489.7

(51) Int. Cl. H01M 50/489; H01M 50/446; H01M 50/457; H01M 10/0525

(52) U.S. Cl. CPC H01M 50/489; H01M 50/446; H01M 50/457; H01M 10/0525

(57) ABSTRACT

The present invention relates to a separator for lithium-ion cells having improved heat conduction. The separator comprises an electrically insulating carrier material and an electrically insulating but thermally conductive filler contained therein. Furthermore, the invention relates to a lithium-ion cell that comprises such a separator and to a battery module having a plurality of such lithium-ion cells. The use of the separator in a lithium-ion cell to improve the heat transport during charging and discharging cycles is also part of the present invention.

### AREA OF THE INVENTION

The present invention relates to a separator for a lithium-ion cell having improved heat conduction. The separator comprises an electrically insulating carrier material and an electrically insulating but thermally conductive filler contained therein. Furthermore, the invention relates to a lithium-ion cell that comprises such a separator and to a battery module having a plurality of such lithium-ion cells. The use of the separator in a lithium-ion cell to improve the heat transport during charging and discharging cycles is also part of the present invention.

### TECHNICAL BACKGROUND AND PRIOR ART

Lithium-ion cells are typically constructed from four components, namely an anode, a cathode, an electrolyte, and a separator. Although the separator is not actively involved in the electrochemical reactions in the cell, it performs important functions. It is made of an electrically non-conductive polymer and thus represents an electrically insulating barrier between anode and cathode. In addition, the separator is porous and enables a lithium ion flow between the electrodes. The separator is therefore a component that is essential for the operation and performance of the lithium-ion cell and is indispensable.

In addition to the above-mentioned functions, modern separators are also increasingly taking on tasks in the heat management of battery cells.

A separator is described in EP 2 838 137 A1, for example, which counteracts heat development and reduces the risk of thermal runaway in the lithium-ion cell (so-called “thermal runaway”). For this purpose, the separator is designed in multiple layers. It comprises at least one substrate layer based on a polyolefin, one layer made of an inorganic coating, and a further layer made of an organic coating, wherein the two coatings are on opposite sides of the substrate layer. The organic coating has a low melting temperature and therefore begins to flow already at an early stage of a thermal event. This closes the pores in the separator and prevents further lithium ion exchange between the electrodes. The inorganic coating contributes to increased dimensional stability of the separator in order to minimize the risk of the separator shrinking at elevated temperatures and a short-circuit occurring between the electrodes.

In comparison to lithium-ion cells having a single polyolefin layer between anode and cathode, such a separator offers improved protection against runaway of the cell. However, the coating of the separator also has the result that an emergency shutdown and irreversible structural changes already occur prematurely at only moderately elevated temperatures. The result is that the entire battery becomes unusable.

EP 2 871 692 A1 proposes a similar concept. The lithium-ion flow is also to be stopped here by a slightly melting separator in case of a thermal event beginning in the battery. In contrast to EP 2 838 137 A1, the easily melting separator is used in the stack cell in alternation with a further separator which comprises a substrate coated using inorganic material. It is explained that such a structure, which uses different types of separators, would result in better heat dissipation and a lower temperature at the cell surface in the event of a nail-shaped penetration of the cell.

It remains unclear whether the structure of the lithium-ion cell described in EP 2 871 692 A1 also proves its worth in situations in which a thermal event is not artificially triggered by a nail-shaped penetration. In addition, there is still the problem that the battery can no longer be used after the occurrence of elevated temperatures.

US 2015/0111086 A1 also discloses a separator which is supposed to be able to stop the flow of lithium ions between the electrodes from a temperature of 100° C., without losing its shape. The separator here contains a polymer membrane coated on at least one side, wherein the coating comprises a ceramic material and a matrix cured by UV or electron beams. In summary, it has been shown that all known lithium-ion cells use coated polymer membranes as separators. The separators are designed in such a way that they become impermeable to lithium ions from a predetermined temperature, but retain their macroscopic form due to inorganic coatings. The heat conduction properties of the separators are neglected in all approaches in the prior art and are insufficient and in need of improvement.

### OBJECT OF THE INVENTION

The present invention has the object of overcoming the disadvantages known from the prior art. One goal of the present invention was to provide a separator for a lithium-ion cell which has increased thermal conductivity and in this way can maintain the functionality of the battery cell at moderately elevated temperatures for as long as possible. A further goal was to identify advantageous uses of the separator. In addition, a lithium-ion cell and a battery module having improved thermal management are to be specified.

### SUMMARY OF THE INVENTION

These objects are achieved by the separator according to the invention having the features of the independent claim and by the lithium-ion cell and the battery module, which comprise this separator.

The separator according to the invention comprises an electrically insulating, porous carrier material which contains an electrically insulating but thermally conductive ceramic filler therein, wherein the filler is selected from the group consisting of carbides, nitrides, borides, and mixtures thereof.

Due to the distribution of ceramic material as a filler in the carrier material, the separator according to the invention has a thermal conductivity that is uniform over the entire volume. Heat can be better dissipated or discharged, so that the risk of excessive heat development in the vicinity of the separator and of a subsequent separator breakthrough is contained. At the same time, the addition of ceramic fillers also increases the mechanical strength of the carrier material. In addition, the electrical insulating effect of the separator is not impaired by the introduction of the ceramic filler into the carrier material. In addition, the electrical insulation of the thermally conductive ceramic material remains intact even after the carrier material has possibly melted in case of a thermal runaway. This prevents direct electrical contact of positive and negative electrodes, even in case of a thermal runaway, and increases the safety of the cell.

The filler is preferably present in particulate form in a layer of carrier material. The particles preferably have an average diameter of 0.05 to 5 μm, particularly preferably 0.08 to 2 μm.

The filler is preferably distributed homogeneously or approximately homogeneously in the carrier material. In the context of the present invention, “approximately homogeneous” means that the filler concentration profile is constant over the entire thickness of the carrier material layer. In particular, the filler is not only to be contained in the superficial layers of the separator. An at least approximately homogeneous distribution of the filler in the carrier material can be achieved by adding the filler to the carrier material or the starting material for the production of the carrier material in powder form and then mixing it intensively.

In a preferred embodiment, the thermally conductive ceramic filler has a thermal conductivity at 20° C. of at least 50 W/mK, preferably at least 60 W/mK, particularly preferably at least 80 W/mK, in particular at least 90 W/mK.

These thermal conductivities are higher than the thermal conductivities of oxides, which are often used in conventional separators as an inorganic coating material to increase safety. Aluminum oxide (Al₂O₃), for example, only has a thermal conductivity of 25 W/mK. The thermal conductivity of magnesium oxide (MgO), at approximately 45 W/mK, also falls short of the preferred thermal conductivities of the ceramic fillers.

It is particularly advantageous if the filler is selected from the group consisting of silicon carbide (SiC), boron nitride (BN), aluminum nitride (AlN), boron carbide (B₄C), titanium diboride (TiB₂), calcium hexaboride (CaB₆), Zirconium diboride (ZrB₂), and mixtures thereof. Boron nitride is particularly preferred because it has the highest thermal conductivity at 400 W/(mK). Pure silicon carbide also has a high thermal conductivity of approximately 350 W/(mK).

The filler can be contained in the separator in a proportion of 0.5-75% by weight, based on the weight of the carrier material. A content of 5 to 70% by weight, in particular 30 to 60% by weight, of filler, based on the weight of the carrier material, is particularly preferred.

In addition to the fillers, which are selected from the group consisting of carbides, nitrides, borides, and mixtures thereof, additives can be included in the carrier material. For example, other ceramic materials such as aluminum oxide or silicon oxide can be included as additives. The additives can be added, inter alia, to increase the electrical insulation in case of a thermal runway. The proportion of the further additives is preferably less than 10% by weight, in particular less than 5% by weight, based on the weight of the carrier material. The carrier material preferably comprises at least 90% by weight, preferably at least 95% by weight, of a polymer. In particular, the carrier material consists of a polymer. The polymer is preferably selected from the group consisting of polyethylene, polypropylene, polyethylene terephthalate, fluorosilicone rubber, silicone rubber, polyvinylidene fluoride, polyvinylidene fluoride-co-hexafluoropropylene, polyacrylonitrile, polyetheretherketone, and blends thereof.

Furthermore, it is preferred if the separator has a thickness of 5 to 60 μm. A thickness of 7 to 50 μm is particularly preferred. The separator very particularly preferably has a thickness of 10 to 30 μm.

The carrier material is preferably in the form of a film, membrane, nonwoven layer, or fabric layer. These structures can be manufactured in a known manner and without great effort in such a way that they have a certain porosity. The porosity contributes to the desired lithium ion permeability of the separator.

Furthermore, the separator can be formed either as a single layer or as a laminate made up of multiple layers. For reasons of cost and in order to save process steps in production and thereby simplify production, the single-layer embodiment of the separator is preferred.

In a special embodiment, the separator according to the invention is therefore a layer made of a polymer carrier material in which filler particles are distributed, wherein the filler particles are selected from the group consisting of carbides, nitrides, borides, and mixtures thereof and wherein the content of filler particles is 0.5-75% by weight, particularly preferably 5-70% by weight, in particular from 30 to 60% by weight, based on the weight of the polymer carrier material.

For the case that the separator is a laminate made up of multiple layers, the layers can all comprise the same substrate or different substrates. Each carrier material or each layer can contain a thermally conductive ceramic filler selected from the group consisting of carbides, nitrides, borides, and mixtures thereof.

The separator can include one or two functionalized surfaces. The functionalized surface can be obtained by grafting, coating, and/or plasma methods. The functionalized surface preferably contributes further to increasing the thermal conductivity and/or it has a reinforcing function and improves the dimensional stability and/or the wettability of the separator.

In a preferred variant, the separator has an electrical conductivity of at most 10⁻⁶ S·cm-1, preferably at most 10⁻⁸ S·cm-1. These low electrical conductivities give the separator the function as an electrical insulator and prevent a short circuit from occurring between the electrodes when the cell is in operation.

An advantageous use of the separator according to the invention results in a lithium-ion cell. Here the separator according to the invention can be used to improve the heat transport during charging and discharging cycles. Heat can be transported to the cell surface more efficiently by the separator. The use of the separator in a lithium-ion cell during a rapid charging cycle, in which a large amount of heat is generated in a short time, is particularly advantageous.

The present invention also provides a lithium-ion cell, which comprises at least one electrolyte and a pair of electrodes consisting of a cathode and an anode, wherein the above-described separator is arranged between the cathode and the anode.

In the cell according to the invention, the separator emits the heat that arises during normal operation of the cell at the surface of the cell and in this way prevents an undesirable heat buildup inside the cell. The temperature is distributed more evenly and efficiently, and the thermal connection of the cell core to the surrounding cell housing is improved.

Such a lithium-ion cell has a longer service life than previously known lithium-ion cells from the prior art. On the one hand, the aging of the cells decreases because there are no excessively elevated temperatures in the interior of the cell. On the other hand, there are fewer premature failures since local temperature increases in the cell do not immediately result in irreversible structural changes in the separator.

The lithium-ion cell is preferably selected from the group consisting of cylindrical cells, prismatic cells, wound cells, stacked cells, and pouch cells.

A further aspect of the present invention relates to a battery module which comprises a plurality of the above-described lithium-ion cells.

### DESCRIPTION OF THE PREFERRED EMBODIMENTS

Preferred embodiments of the invention are explained in more detail with reference to the following figures and experiments, without wishing to restrict the invention thereto.

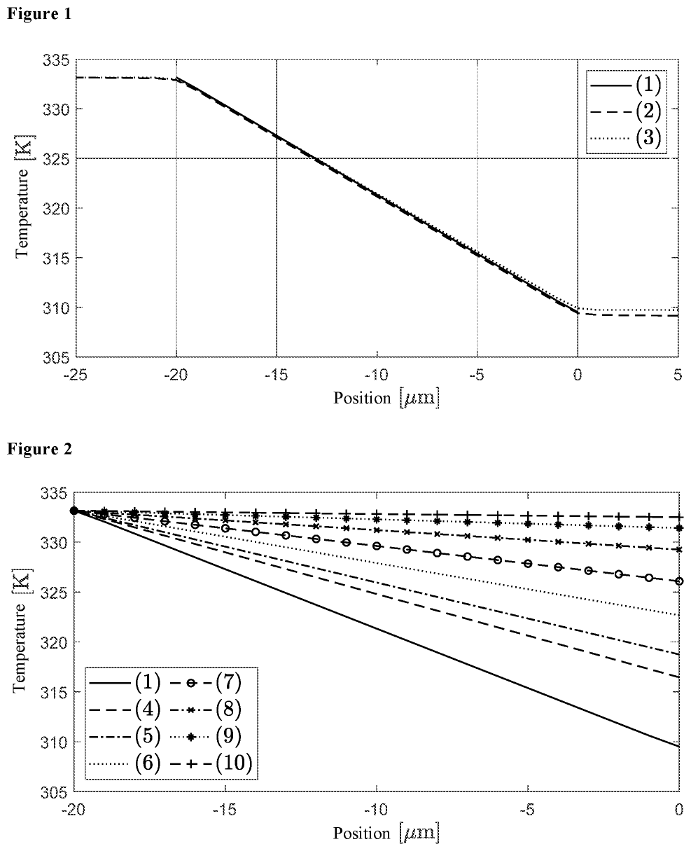

FIG. 1 shows temperature profiles determined by means of a computer simulation, which occur across the thickness of the separators in conventional separators assuming specific heat sources and heat sinks.

FIG. 2 shows temperature profiles determined by means of a computer simulation, which occur in separators according to the invention having different filler contents, also assuming specific heat sources and heat sinks, across the thickness of the separators, and compares these to a temperature profile that occurs under the same conditions in a separator not according to the invention.

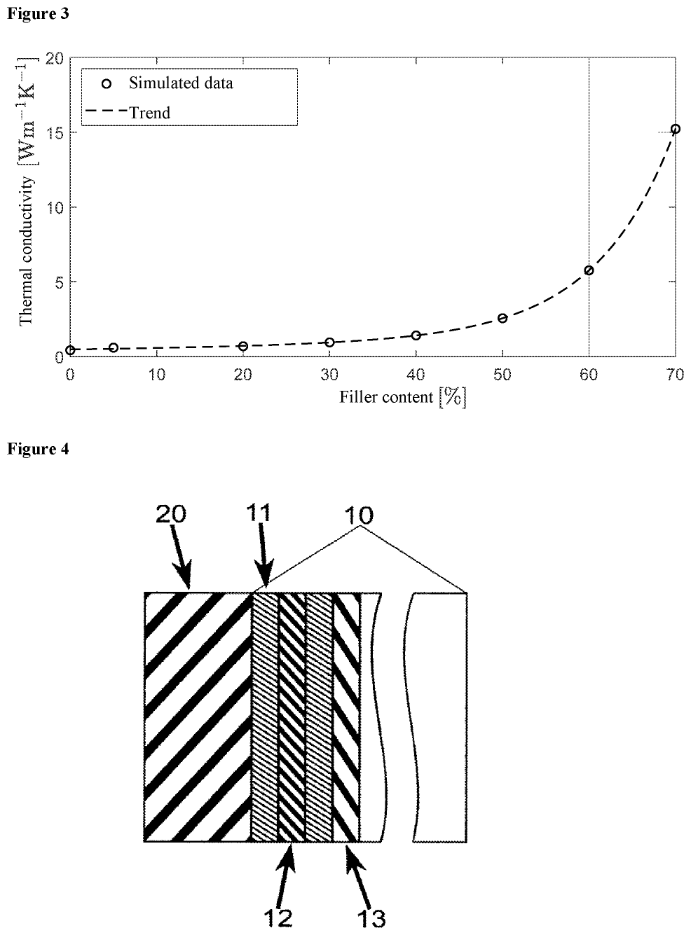

FIG. 3 shows the correlation of thermal conductivity with filler content.

FIG. 4 shows a schematic diagram of a lithium-ion cell according to the invention.

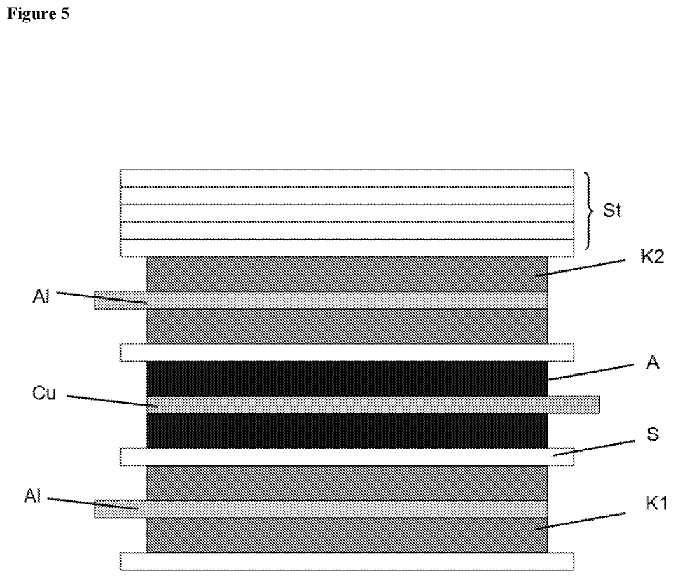

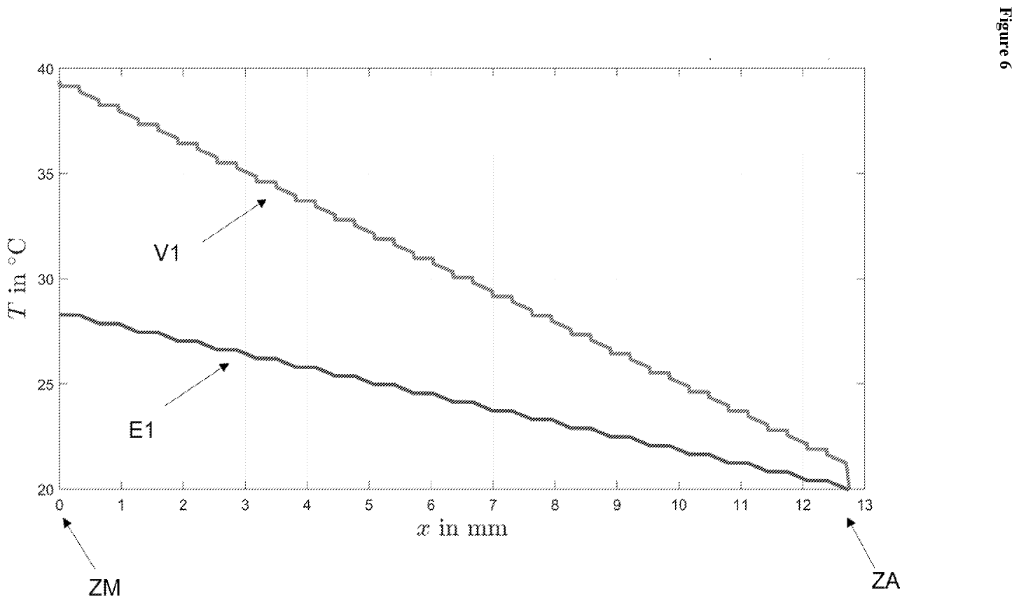

FIG. 5 shows a further schematic diagram of a lithium-ion cell according to the invention, in which the cell is constructed as a bi-cell.

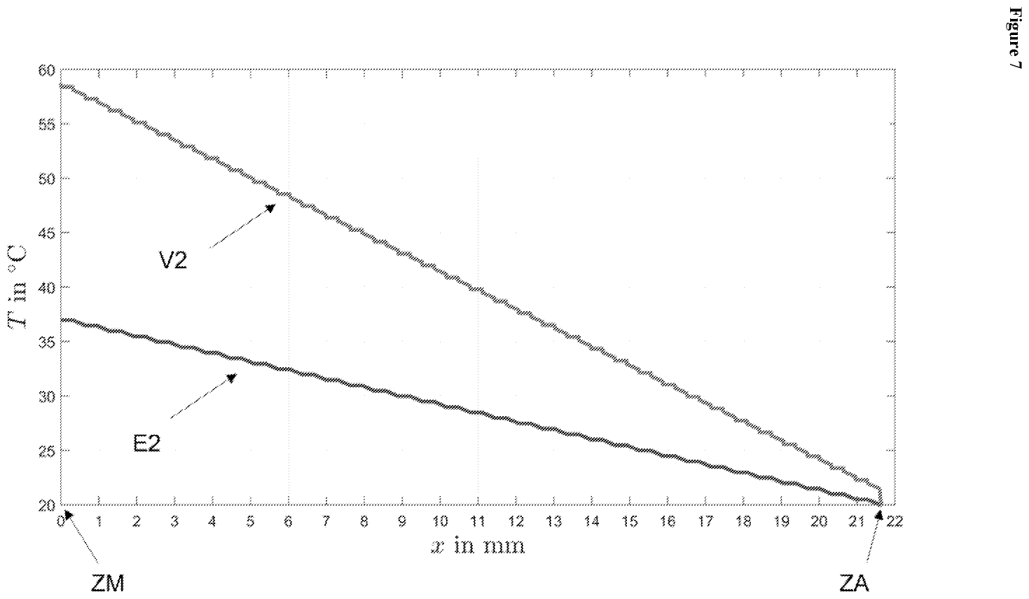

FIG. 6 shows temperature profiles determined by means of a computer simulation, which occur during rapid charging of two 51 Ah cells (NMC 622) from the cell center point ZM to the cell outside ZA. In this case, one of the two cells comprises a separator E1 according to the invention and the other cell comprises a conventional separator V1.

FIG. 7 shows temperature profiles determined by means of a computer simulation, which occur during rapid charging of two 156 Ah cells (NMC 811) from the cell center point ZM to the cell outside ZA. In this case, one of the two cells comprises a separator E2 according to the invention and the other cell comprises a conventional separator V2. The separators known in the prior art consist of a polymer membrane, for example a polyethylene membrane (1), or of a polymer membrane coated using an inorganic material. In the present studies, a polyethylene membrane (2) coated on both sides using aluminum oxide and a polyethylene membrane (3) coated on both sides using boron nitride were selected as examples of the polymer membranes coated using inorganic material.

The temperature profiles resulting across the thickness of the above-mentioned separators (1)-(3) were calculated by means of a computer simulation assuming specific heat sources and heat sinks on the two sides of the separator. The following framework conditions were selected for these simulations:
Thickness of the separator=20 micrometers
Thickness of the coating (if present)=5 micrometers
Particle size of the inorganic material (alumina/boron nitride)=0.1 micrometers (corresponding to the diameter of particles assumed to be spheres)
Thermal conductivity of boron nitride=400 W/mK
Thermal conductivity of aluminum oxide=25 W/mK
Thermal conductivity of polyethylene=0.42 W/mK
the left side of the separator is heated to a temperature of 60° C. or 333.15 K.
the right side of the separator is cooled at a constant cooling capacity of 0.01 W.

The temperature profiles which result in the equilibrium state across the conventional separators (1)-(3) are plotted in the diagram in FIG. 1. It is true here that a high thermal conductivity of the separator results in a small temperature gradient between the right and left side of the separator.

The temperature profiles across the separators (1) and (2) show a very similar temperature curve from the left side, i.e., at a position of −20 μm for separator (1) and a position of −25 μm for separator (2), to the right side, i.e., at a position of 0 μm for separator (1) and a position of 5 μm for separator (2). Coating both sides using aluminum oxide therefore does not result in a noticeably improved thermal conductivity of the separator. The temperature curve that results in the separator (3) deviates slightly from the temperature profiles across the separators (1) and (2). The temperature difference between the right and left side at separator (3) is slightly lower than the temperature difference at the separators (1) and (2). The relationship between the temperature profiles corresponds to expectations: Due to its relatively low thermal conductivity, aluminum oxide is not able to dissipate the accumulated heat to the environment particularly quickly. On the other hand, boron nitride has a relatively high thermal conductivity, and contributes to reducing the temperature difference between the left side of the separator (the interior of the battery cell) and the right side of the separator (the surface of the battery cell). However, a major effect on the temperature profile cannot be observed even in the separator coated on both sides using boron nitride. This situation can be significantly improved by introducing boron nitride (BN) into the polyethylene as a filler. This is shown by the diagram in FIG. 2, in which the simulated temperature profiles of separators (4) to (9) according to the invention are plotted and compared to a temperature profile of a separator not according to the invention without filler (1). The separators have different proportions of filler according to Table 1. The simulation conditions were chosen to be identical to those in the simulations described in connection with FIG. 1.

TABLE 1

| | proportion of BN in % | simulated thermal conductivity of |
|---|---|---|
| separator | by weight | the separator in W/m · K |
| (1) | 0 | 0.42 |
| (4) | 5 | 0.60 |
| (5) | 20 | 0.70 |
| (6) | 30 | 0.95 |
| (7) | 40 | 1.41 |
| (8) | 50 | 2.56 |
| (9) | 60 | 5.77 |
| (10) | 70 | 15.22 |

The dependency of the separator thermal conductivity on the content of filler is shown in FIG. 3. In this diagram, the points represent the simulated data. A trend line is additionally drawn. In the diagram, together with FIG. 2, it is apparent that even small additions of thermally conductive ceramic material to the separator can be expected to decrease the temperature difference across the separator. Despite the strongly increasing thermal conductivity from 60% to 70% filler content, only a small change in the temperature difference between the two sides of the separator is achieved, since the temperature equalization is already almost complete from a solid content of 60%.

FIG. 4 shows a schematic diagram of a lithium-ion cell according to the invention. The stack 10 consists here of the positive electrode 12, the negative electrode 13, and two separators 11 containing a ceramic filler. A separator is arranged between the electrodes as an electrically insulating barrier, while a second separator represents a connection of the stack to the cell housing 20.

FIG. 5 shows the layered structure of a stacked bi-cell having an anode A, cathodes K1 and K2, two separators S located within the stack, and conductors made of copper Cu and aluminum Al. The stack is delimited by a further separator layer S at the bottom. On the upper side of the cell stack, which forms the outer side of the coil after it has been wound, there is a stack St made up of multiple separator layers (here: five). This gives the cell mechanical stability and ensures electrical insulation of the cell stack/cell coil from the housing. At the same time, the provision of the stack St made up of multiple separator layers reduces the thermal conductivity on one side of the cell stack or on the outer side of the cell coil.

Using two cell types (cell type 1 and cell type 2) having such a bi-cell layer structure, it was studied how the type of separator affects the heat dissipation in the battery during a fast charging process (“5C charging”) at ambient temperature. For this purpose, the temperature profile was simulated which results when heat is generated homogeneously at the cell center point ZM of the stacked bi-cell (unwound) and a temperature of 20° C. is present on the cell outside ZA.

Cell type 1 is an NMC 622 cell having a capacity of 51 Ah, dimensions of 148×91×26.5 mm (l×h×w), and a weight of 925 g. Cell type 2 is an NMC 811 cell having a capacity of 156 Ah, dimensions of 220×101.6×44.3 mm (l×h×w) and a weight of 2315 g.

In the simulation of conventional cells V1 and V2, it was assumed that the separator consists of polyolefin and contains no filler (see Table 2). In the simulation of cells E1 and E2 according to the invention, it was assumed that the separator consists of polyolefin as the carrier material and boron nitride as the filler, wherein polyolefin and boron nitride are present in a weight ratio of 4:6 (see Table 3).

TABLE 2
Properties of the layers in the simulation of cells V1 and V2.

| | material | thermal conductivity | | thickness | |
|---|---|---|---|---|---|
| cathode | NMC | ~5 | W/(m K) | 150 | μm |
| anode | graphite | 170 | W/(m · K) | 150 | μm |
| separator | polyolefin | 0.27 | W/(m · K) | 10 | μm |
| Cu conductor | copper | 399 | W/(m · K) | 5 | μm |
| Al conductor | aluminum | 240 | W/(m · K) | 10 | μm |

TABLE 3
Properties of the layers in the simulation of cells E1 and E2.

| | material | thermal conductivity | | thickness | |
|---|---|---|---|---|---|
| cathode | NMC | ~5 | W/(m · K) | 150 | μm |
| anode | graphite | 170 | W/(m · K) | 150 | μm |
| separator | polyolefin + BN (4:6) | 160 | W/(m · K) | 10 | μm |
| Cu conductor | copper | 399 | W/(m · K) | 5 | μm |
| Al conductor | aluminum | 240 | W/(m · K) | 10 | μm |

The results of the simulation can be seen in FIGS. 6 and 7 and show that the heat dissipation from the cell interior is better in both cell types if separators according to the invention having boron nitride as a filler are used.

The same result is also obtained when using other materials as filler, for example silicon carbide. Since the thermal conductivity of silicon carbide differs only slightly from that of boron nitride, only the weight ratio of filler to carrier material is to be adjusted for this purpose.

1. A separator for a lithium-ion cell, comprising an electrically insulating carrier material which contains an electrically insulating but thermally conductive ceramic filler therein, wherein the filler is selected from the group consisting of carbides, nitrides, borides, and mixtures thereof.

2. The separator as claimed in claim 1, wherein the thermally conductive ceramic filler has a thermal conductivity at 20° C. of at least 50 W/mK, preferably at least W/mK, particularly preferably at least 80 W/mK, in particular at least 90 W/mK.

3. The separator as claimed in at least one of the preceding claims, wherein the filler is selected from the group consisting of silicon carbide, boron nitride, aluminum nitride, boron carbide, titanium diboride, calcium hexaboride, zirconium diboride, and mixtures thereof.

4. The separator as claimed in at least one of the preceding claims, wherein the filler is included in a proportion of 0.5-75% by weight, preferably 5-70% by weight, particularly preferably 30-60% by weight, based on the weight of the carrier material.

5. The separator as claimed in at least one of the preceding claims, wherein the carrier material comprises at least 90% by weight, preferably at least 95% by weight, of a polymer selected from the group consisting of polyethylene, polypropylene, polyethylene terephthalate, fluorosilicone rubber, silicone rubber, polyvinylidene fluoride, polyvinylidene fluoride-co-hexafluoropropylene, polyacrylonitrile, polyetheretherketone, and blends thereof.

6. The separator as claimed in at least one of the preceding claims, wherein the separator has a thickness of 5-60 μm, preferably 7-50 μm, particularly preferably 10-30 μm.

7. The separator as claimed in at least one of the preceding claims, wherein the carrier material is present as a film, membrane, nonwoven layer, or as a fabric layer.

8. The separator as claimed in at least one of the preceding claims, wherein the separator is designed as a single layer or as a laminate made up of multiple layers, wherein the layers comprise the same carrier material or different carrier materials, each of which contains a thermally conductive ceramic filler selected from the group consisting of carbides, nitrides, borides, and mixtures thereof.

9. The separator as claimed in at least one of the preceding claims, wherein the separator has at least one functionalized surface, preferably a surface functionalized by grafting, coating, and/or plasma methods.

10. The separator as claimed in at least one of the preceding claims, wherein the separator has an electrical conductivity of at most 10⁻⁶ S·cm⁻¹, preferably at most 10⁻⁸ S·cm⁻¹.

11. A lithium-ion cell comprising at least one electrolyte, a pair of electrodes consisting of a cathode and an anode, wherein a separator as claimed in at least one of the preceding claims is arranged between the cathode and the anode.

12. The lithium-ion cell as claimed in the preceding claim, wherein the lithium-ion cell is selected from the group consisting of cylindrical cells, prismatic cells, wound cells, stacked cells, and pouch cells.

13. A battery module comprising a plurality of lithium-ion cells as claimed in at least one of claims 11 and 12.

14. A use of a separator as claimed in at least one of claims 1-10 in a lithium-ion cell to improve heat transport during charging and discharging cycles.
